(19) United States
(12) Patent Application Publication
(10) Pub. No.: US 2011/0238599 A1
(43) Pub. Date: Sep. 29, 2011

(54) KESSMADE PET CARRIER SYSTEMS

(76) Inventor: Kesler Pineda Torrentes, Pennsauken, NJ (US)

(21) Appl. No.: 13/052,101

(22) Filed: Mar. 20, 2011

Related U.S. Application Data
(60) Provisional application No. 61/316,506, filed on Mar. 23, 2010.

(51) Int. Cl. A01K 1/00; G06Q 90/00

(52) U.S. Cl. 705/500; 119/497

(57) ABSTRACT

A pet carrier comprising a cage-like enclosure having a top and a bottom, a front end and a rear end, a first side and a second side, a handle, four wheels, and a door. The upper half of the first side and of the second side of the cage-like enclosure comprises window-like ventilation openings which are covered by mesh and the door is receiveable within the rear end and comprises a locking mechanism. The handle is attached to the top of the cage-like enclosure. Two of the four wheels are attached to the bottom near the front end and two of the four wheels are attached to the bottom near the rear end of the cage-like enclosure. The cage-like enclosure simulates a vehicle-form such as for example a school bus or a fire truck.

### CROSS-REFERENCE TO RELATED APPLICATION

The present application is related to and claims priority from prior provisional application Ser. No. 61/316,506, filed Mar. 23, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of pet products and more specifically relates to a pet carrier for transporting small animals.

2. Description of the Related Art

Animals make great companions, offer health benefits to their owner, and can be a source of enduring affection. More Americans own pets than ever before, and they're spending more money to keep them healthy and happy and are always looking for new and unique products to add to their collection. Many Americans enjoy the company of their pet while they are travelling and usually use pet carriers to safely transport their pets. Pet carriers are also needed to transport pets to the veterinarian or to keep the pet safe while it is in a public place.

Unfortunately, most pet carriers are generically shaped and mundanely colored. They usually have a rectangular shape with a door with vents at the front and come in colors such as grey or beige. While various accessories for pets such as collars or pet beds come in cheerful, fun colors and shapes, pet carriers all look very similar and resemble each other. Therefore a need exists for a more unique and colorful pet carrier which promotes fun while travelling with your pet or transporting a pet and which contributes to the joyful experience of having your pet with you while travelling.

Various attempts have been made to solve the above-mentioned problems such as those found in U.S. Pat. Nos. D308,429; D574,559; and 5,193,486. This prior art is representative of pet products. None of the above inventions and patents, taken either singly or in combination, is seen to describe the invention as claimed.

Ideally, a pet carrier for transporting small animals should require no maintenance, be easy to clean, have a pleasing appearance and, yet, would operate reliably and be manufactured at a modest expense. Thus, a need exists for a reliable pet carrier system to make it fun to transport a pet and to avoid the above-mentioned problems.

### BRIEF SUMMARY OF THE INVENTION

In view of the foregoing disadvantages inherent in the known pet carrier for transporting small animals art, the present invention provides a novel pet carrier system. The general purpose of the present invention, which will be described subsequently in greater detail, is to provide a reliable pet carrier system which makes it fun to transport a pet.

A pet carrier is disclosed herein comprising a cage-like enclosure which simulates the general shape of a vehicle having a top and a bottom, a front end and a rear end, a first side and a second side, a handle, four wheels, and a door.

The upper half of the first side and of the second side of the cage-like enclosure comprises window-like ventilation openings which are covered by mesh made of steel. The swingably hinged door which comprises rear-ventilation-openings which are covered by a steel mesh-grid is receivable within the rear end and comprises a locking mechanism. The handle is attached to the top of the cage-like enclosure. Two of the four functionally rotatable wheels are attached to the bottom near the front end while the other two of the four functionally rotatable wheels are attached to the bottom near the rear end of the cage-like enclosure. The cage-like enclosure simulates a vehicle-form, such as for example the form, color and insignia of a school bus.

A kit is also described herein including at least one cage-like enclosure, at least one handle, at least four wheels, at least one door, and a user instruction manual.

A method of monetizing a pet carrier is also disclosed herein comprising the steps of: manufacturing a pet carrier which simulates a vehicle form, insignia and color; distributing for sale the pet carrier to pet shelters, pet adoption centers and pet stores; and offering a user who is in the process of adopting a pet the pet carrier for a reduced price to create at least one monetization for the creator of the pet carrier, and/or at least one wholesaler and/or at least one retailer.

Further, a method for using a pet carrier is disclosed herein comprising the steps of: placing a pet in a cage-like enclosure comprising the general form of a vehicle; closing a door of the cage-like enclosure comprising the general form of a vehicle; transporting the pet in the cage-like enclosure comprising the general form of a vehicle; opening the door of the cage-like enclosure comprising the general form of a vehicle; and taking the animal out of the cage-like enclosure comprising the general form of a vehicle.

The present invention holds significant improvements and serves as a pet carrier system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments for the present invention, Kessmade Pet Carrier Systems, constructed and operative according to the teachings of the present invention.

FIG. 1 shows a perspective view illustrating a pet carrier in an in-use condition according to an embodiment of the present invention.

FIG. 2 is a perspective view illustrating the pet carrier according to an embodiment of the present invention of FIG. 1.

FIG. 3 is a perspective view illustrating the pet carrier according to another embodiment of the present invention.

FIG. 4 is a perspective view illustrating the pet carrier according to another embodiment of the present invention.

The various embodiments of the present invention will hereinafter be described in conjunction with the appended drawings, wherein like designations denote like elements.

### DETAILED DESCRIPTION

As discussed above, embodiments of the present invention relate to a pet product device and more particularly to a pet carrier used to transport small animals.

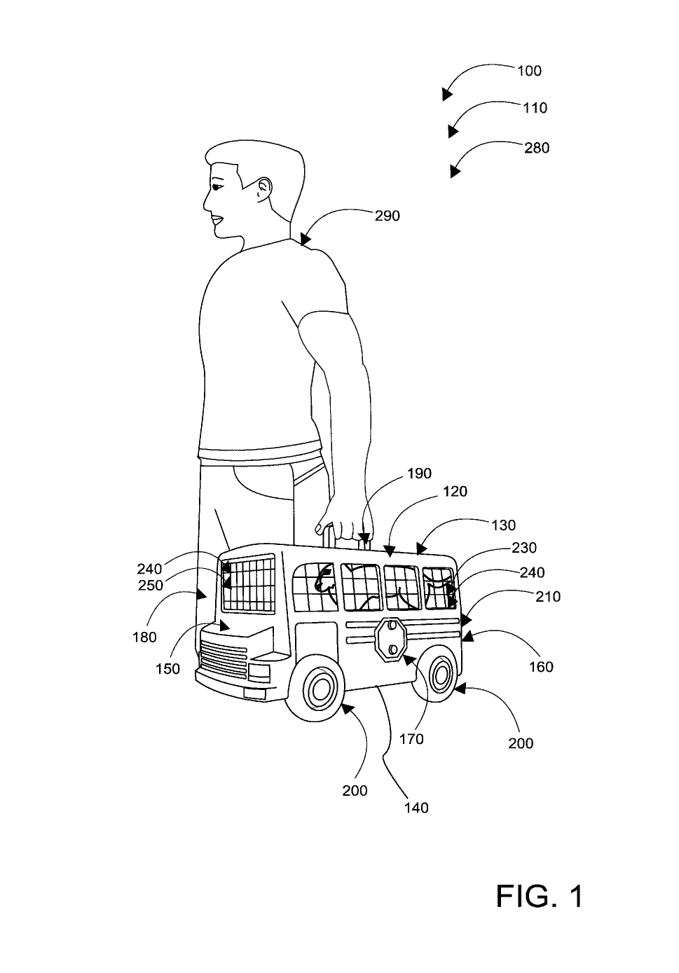

Referring to the drawings by numerals of reference there is shown in FIG. 1, a perspective view illustrating pet carrier 110 in ‘in-use’ condition 280 according to an embodiment of the present invention.

Pet carrier 110 preferably comprises cage-like enclosure 120 having top 130 and bottom 140, front end 150 and rear end 160, first side 170 and second side 180, handle 190, four wheels 200, and door 210.

Cage-like enclosure 120 comprises top 130 and bottom 140, front end 150 and rear end 160, first side 170 and second side 180. Cage-like enclosure 120 is preferably formed as a single piece construction and preferably measures 24 inches in length, xx inches in width, and 22 inches in height. However, pet carrier 110 may be produced in a variety of sizes to accommodate dogs, cats or other animals of varying sizes and breeds. Cage-like enclosure 120 may preferably be manufactured from colored sturdy plastic. Alternatively, cage-like enclosure 120 may comprise canvas or nylon secured to a metal frame.

The exterior of cage-like enclosure 120 may be formed to resemble the exterior of various types of motor vehicles, such as a car, a sports car, a school bus, a fire truck, a construction truck or a police car. Front end 150 may preferably be shaped in such a way as to resemble the front of a motor vehicle and may comprise a miniature plastic bumper, plastic front lights and a plastic grille. Front end 150 may further comprise front-window-like ventilation openings 250 which may preferably be covered by mesh 240 made of steel. The exterior of cage-like enclosure 120 may further comprise the color and insignia of a particular vehicle. For example, the exterior of cage-like enclosure 120 may comprise yellow plastic material, resemble the shape of a school bus and comprise black stripes and other school-bus-typical insignia which may be printed on front end 150, first side 170, and second side 180 so as to simulate the appearance of a school bus.

Upper half 220 of first side 170 and of second side 180 of cage-like enclosure 120 preferably comprises window-like ventilation openings 230. Window-like ventilation openings 230 are shaped in the form of the windows of a simulated vehicle. For example, if the pet carrier 110 comprises the general shape and insignia of a school bus, window-like ventilation openings 230 preferably comprise a square shape so as to reflect the shape of the windows of a real full-sized school bus. Window-like ventilation openings 230 are preferably covered by mesh 240 which preferably comprises steel. However, mesh 240 may comprise any kind of durable and suitable material such as ferrous or non-ferrous material.

As previously mentioned, pet carrier 110 preferably comprises handle 190 which is attached to top 130 of cage-like enclosure 120 so that user 290 may grasp handle 190 to lift and transport pet carrier 110 and an enclosed pet thereby creating ‘in-use’ condition 280. Handle 190 may alternatively comprise an extended handle which is pivotally connected to front end 150 of cage-like enclosure 120 so that user 290 may pull pet carrier 110.

Pet carrier 110 comprises four wheels 200. Two of the four wheels 200 are attached to bottom 140 near front end 150 and two of the four wheels 200 are attached to bottom 140 near rear end 160 of cage-like enclosure 120. The four wheels 200 extend downward from bottom 140 of cage-like enclosure 120 so that when pet carrier 110 is stationary, pet carrier 110 may rest on the four wheels 200. The four wheels 200 are preferably made of rubber and are functionally rotatable so that user 290 may pull pet carrier 110. However, it should be noted that four wheels 200 may only be for decoration and may not be functionally rotatable in certain embodiments.

Pet carrier 110 further comprises door 210 which is receivable within an opening of rear end 160 and is movably connected to rear end 160 via hinges which are attached to one side of door 210 and to rear end 160 so that door 210 may be opened and closed in a pivoting swing motion. Door 210 further comprises a locking mechanism so as to lock a pet securely inside cage-like enclosure 120. Door 210 preferably comprises rear-ventilation-openings 260 made of mesh-grid 270 comprising steel. However, mesh-grid 270 may comprise any kind of durable and suitable material such as plastic or non-ferrous material.

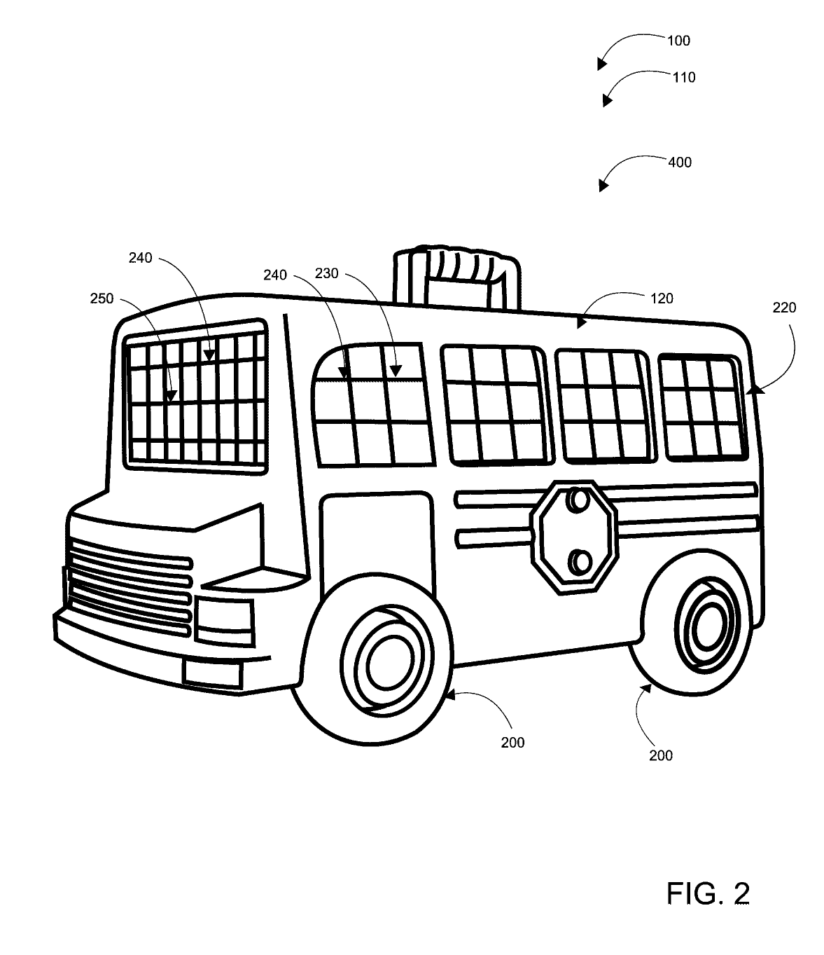

Referring now to FIG. 2, a perspective view illustrating the pet carrier 110 according to an embodiment of the present invention.

As previously mentioned, the exterior of the cage-like enclosure 120 may be formed to resemble the exterior of various types of motor vehicles, such as a car, a sports car, a school bus, a fire truck, a construction truck or a police car. FIG. 2 depicts a perspective view illustrating the pet carrier 110 formed in the general shape of a school bus wherein four wheels 200 resemble the wheels of a school bus, front window-like ventilation openings 250 resemble the windshield of a school bus and the window-like ventilation openings 230 resemble the side windows of a school bus. The cage-like enclosure 120 comprises yellow plastic material and is decorated with black stripes.

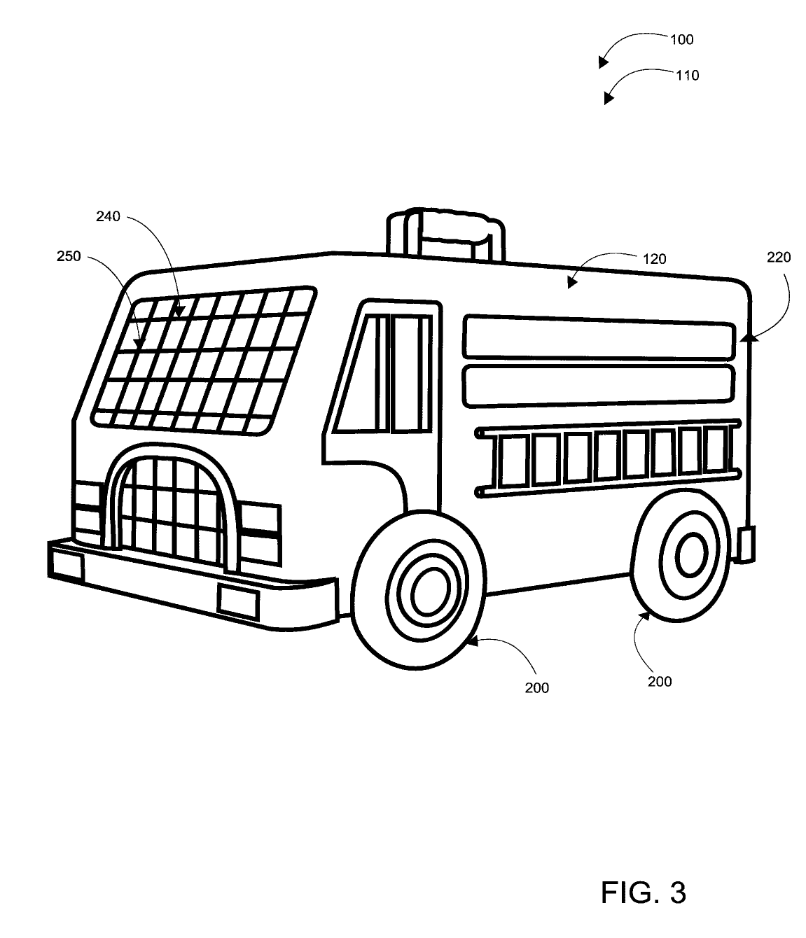

Referring now to FIG. 3, a perspective view illustrating the pet carrier 110 according to another embodiment of the present invention.

FIG. 3 depicts a perspective view illustrating pet carrier 110 formed in the general shape of a fire truck wherein four wheels 200 resemble the wheels of a fire truck, front window-like ventilation openings 250 resemble the windshield of a fire truck and window-like ventilation openings 230 resemble the side windows of a fire truck. Cage-like enclosure 120 comprises red plastic material and is decorated with insignia typically found on fire trucks.

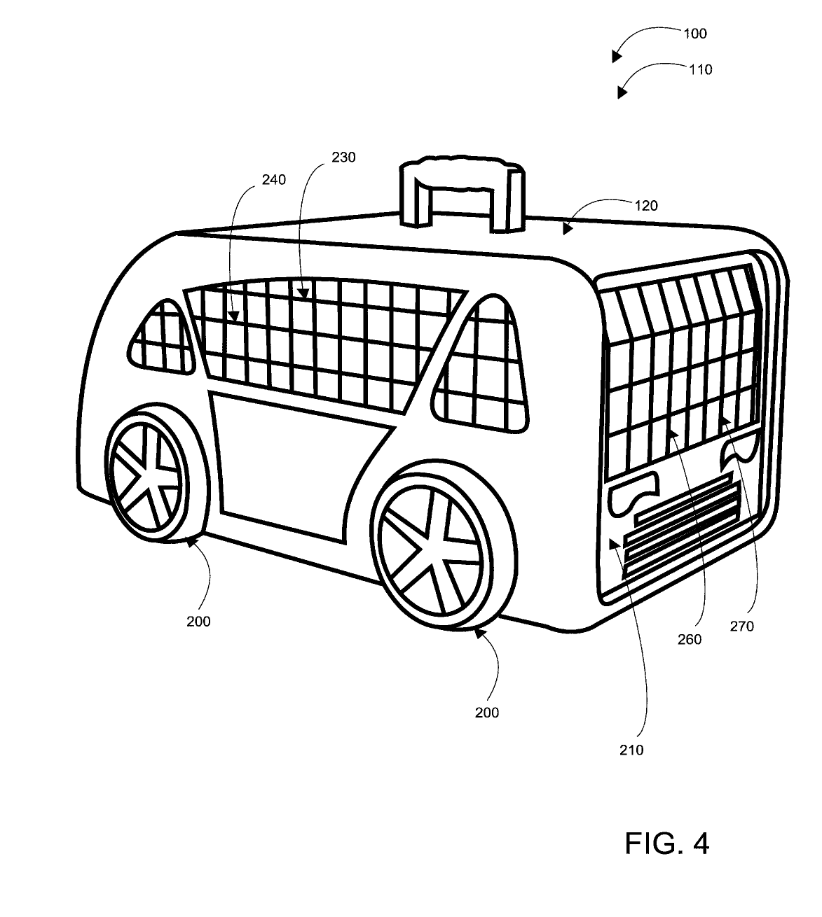

Referring now to FIG. 4, a perspective view illustrating the pet carrier 110 according to another embodiment of the present invention.

FIG. 4 depicts a perspective view illustrating pet carrier 110 formed in the general shape of a car wherein four wheels 200 resemble the wheels of a car, front window-like ventilation openings 250 resemble the windshield of a car and the window-like ventilation openings 230 resemble the side windows of a car. Cage-like enclosure 120 comprises colored plastic material.

Kessmade Pet Carrier Systems 100 may be sold as kit 400 comprising the following parts: at least one cage-like enclosure 120, at least one handle 190, at least four wheels 200, at least one door 210, and at least one user instruction manual.

Kessmade Pet Carrier Systems 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

A method of monetizing a pet carrier 110 may comprise the steps of: step one manufacturing pet carrier 110 which simulates a vehicle form, insignia and color; step two distributing for sale the pet carrier 110 to pet shelters, pet adoption centers and pet stores; and step three offering user 290 who is in the process of adopting a pet pet carrier 110 for a reduced price to create at least one monetization for the creator of pet carrier 110, and/or at least one wholesaler and/or at least one retailer.

A method for using a pet carrier is disclosed herein comprising the steps of: placing a pet in cage-like enclosure 120 comprising the general form of a vehicle; closing a door 210 of the cage-like enclosure 120 comprising the general form of a vehicle; transporting the pet in the cage-like enclosure 120 comprising the general form of a vehicle; opening the door 210 of the cage-like enclosure 120 comprising the general form of a vehicle; and taking the animal out of the cage-like enclosure 120 comprising the general form of a vehicle.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A pet carrier comprising:
a cage-like enclosure having a top and a bottom, a front end and a rear end, a first side and a second side;
a handle;
four wheels; and
a door;
wherein an upper half of said first side and of said second side of said cage-like enclosure comprises window-like ventilation openings which are covered by mesh;
wherein said front end comprises front-window-like ventilation openings which are covered by mesh;
wherein said door is receivable within said rear end and comprises a locking mechanism;
wherein said handle is attached to said top of said cage-like enclosure;
wherein two of said four wheels are attached to said bottom near said front end and two of said four wheels are attached to said bottom near said rear end; and
wherein said cage-like enclosure simulates a vehicle-form.

2. The pet carrier of claim 1 wherein said cage-like enclosure comprises a simulated car-form.

3. The pet carrier of claim 1 wherein said cage-like enclosure comprises a simulated sports car-form and insignia.

4. The pet carrier of claim 1 wherein said cage-like enclosure comprises a simulated school bus form, color, and insignia.

5. The pet carrier of claim 1 wherein said cage-like enclosure comprises a simulated fire truck form, color, and insignia.

6. The pet carrier of claim 1 wherein said cage-like enclosure comprises a simulated construction truck form, color, and insignia.

7. The pet carrier of claim 1 wherein said cage-like enclosure comprises a simulated police car form, color, and insignia.

8. The pet carrier of claim 1 wherein said cage-like enclosure comprises colored plastic.

9. The pet carrier of claim 1 wherein said cage-like enclosure comprises canvas secured to a metal frame.

10. The pet carrier of claim 1 wherein said door comprises rear-ventilation-openings.

11. The pet carrier of claim 10 wherein said rear-ventilation-openings comprise a mesh-grid comprising steel.

12. The pet carrier of claim 10 wherein said rear-ventilation-openings comprise a mesh-grid comprising non-ferrous material.

13. The pet carrier of claim 1 wherein said mesh of said window-like ventilation openings and said front-window-like ventilation openings comprises steel.

14. The pet carrier of claim 1 wherein said mesh of said window-like ventilation openings and of said front-window-like ventilation openings comprises non-ferrous material.

15. The pet carrier of claim 1 wherein said four wheels are functionally rotatable.

16. The pet carrier of claim 1 wherein said door is swingably hinged.

17. A pet carrier comprising:
a cage-like enclosure comprising colored plastic and having a top and a bottom, a front end and a rear end, a first side and a second side;
a handle;
four wheels which are functionally rotatable; and
a swingably hinged door with rear-ventilation-openings;
wherein an upper half of said first side and of said second side of said cage-like enclosure comprises window-like ventilation openings which are covered by mesh comprising steel;
wherein said front end comprises front-window-like ventilation openings which are covered by mesh comprising steel;
wherein said swingably hinged door which comprises rear-ventilation-openings which are covered by a mesh-grid comprising steel is receivable within said rear end and comprises a locking mechanism;
wherein said handle is attached to said top of said cage-like enclosure;
wherein two of said four functionally rotatable wheels are attached to said bottom near said front end and two of said four functionally rotatable wheels are attached to said bottom near said rear end; and
wherein said cage-like enclosure simulates a vehicle-form.

18. The pet carrier of claim 17 wherein said pet carrier further comprises a kit including said at least one cage-like enclosure, said at least one handle, said at least four wheels, said at least one door, and a user instruction manual.

19. A method of monetizing a pet carrier comprising the steps of:
manufacturing a pet carrier which simulates a vehicle form, insignia and color;
distributing for sale said pet carrier to pet shelters, pet adoption centers and pet stores; and
offering a user who is in the process of adopting a pet said pet carrier for a reduced price to create at least one monetization for the creator of said pet carrier, and/or at least one wholesaler and/or at least one retailer.
